(19) United States
(12) Patent Application Publication
(10) Pub. No.: US 2004/0174968 A1
(43) Pub. Date: Sep. 9, 2004

(54) Facsimile

(75) Inventor: Naoki Cho, Kasuga-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/792,790

(22) Filed: Mar. 5, 2004

(30) Foreign Application Priority Data
Mar. 7, 2003 (JP) 2003-062242

(51) Int. Cl. H04M 11/00; H04M 1/56; H04M 15/06

(52) U.S. Cl. 379/100.01; 379/100.15; 455/414.1

(57) ABSTRACT

A facsimile according includes a telephone controller for controlling communications with its handsets and a facsimile communications controller for controlling facsimile communications, wherein the telephone controller includes a radio communications section for performing radio communications with the handsets, a line controller connected to a telephone line for receiving various signals such as a ringing signal, a speech signal and a facsimile signal as well as controlling the lines, a first management section for controlling voice communications and communications related to the facsimile signal, and a first communications section for performing serial communications of a facsimile signal with the facsimile communications controller, that the facsimile communications controller includes a second communications section for performing serial communications of a facsimile signal from a first communications section of the telephone controller and a second management section for receiving a facsimile signal from the second communications section and managing the facsimile function, and that the line controller includes a ringing detection controller and when the ringing detection controller has detected a ringing signal from the telephone line, the first management section instructs the radio communications section to transmit a ringing request signal to the handsets.

### BACKGROUND OF THE INVENTION

1. Field of the Invention

The present invention relates to a facsimile equipped with a telephone function to communicate with handsets.

2. Description of the Related Art

A related art telephone set has had only one handset. Recently, a telephone set has been proposed which is equipped with a plurality of handsets and a multifunctionality to allow simultaneous communications and communications between the handsets (the Japanese Patent Laid-Open No. 2002-232518).

This telephone set is basically designed for voice communications and is not capable of data communications. Thus, a facsimile equipped with handsets has been proposed wherein the facsimile in widespread use in homes and offices is used as a base. The facsimile equipped with handsets can be used as a multifunctional terminal capable of performing voice communications and data communications in homes and offices.

However, such a related art facsimile equipped with handsets has been developed based on a philosophy of mounting a telephone set onto a facsimile. As a result, a G3 facsimile and a telephone set both connected to analog telephone lines employ separate line control systems and interfaces as well as individual processors (hereinafter referred to as CPUs) due to the history of development of the CPUs. This has resulted in a high system cost. To be more precise, when the CPU of this telephone set is mounted as a slave of the CPU of the facsimile, an interface is required between this CPU and the CPU of the facsimile, which results in a delay in the communications between the two CPUs. This causes the facsimile to be rung before the telephone set in response to a same incoming call.

The related art facsimile equipped with handsets is described below referring to drawings. FIG. 3 is a block diagram of a related facsimile equipped with handsets.

In FIG. 3, a numeral 31 denotes a cordless phone controller for controlling eight cordless phones 52 through 59 added to a facsimile (mentioned later). A numeral 32 denotes a line controller of a cordless phone controller for detecting various signals flowing over telephone lines. A numeral 33 denotes a ringing detector for detecting a ringing signal. A numeral 34 denotes a caller ID signal detection controller for detecting the name and the telephone number of the caller. A numeral 35 denotes a voice VOX signal detection controller in a cordless phone controller necessary to determine whether a voice recording on the road incoming to a phone-answering machine is valid.

A numeral 36 denotes a cordless phone state management section for managing the operating states of the eight cordless phones. A numeral 38 denotes a serial communications controller in the cordless phone controller for communicating between the CPU in the facsimile main unit controller and the CPU in the cordless phone controller. A numeral 39 denotes a facsimile main unit controller for implementing the functions of the facsimile including facsimile communications, a copier and a printer. A numeral 40 denotes a facsimile/cordless phone common state management section for performing overall management of the states of both the facsimile main unit controller and the cordless phone controller.

A numeral 41 denotes a serial communications controller in the cordless phone controller for communicating between the CPU in the facsimile main unit controller and the CPU in the cordless phone controller. A numeral 42 denotes a line controller of a cordless phone controller for detecting various signals flowing over telephone lines. A numeral 43 denotes a ringing detector of a facsimile main unit controller for detecting a ringing signal. A numeral 44 denotes a caller ID signal detection controller in a facsimile main unit controller for detecting the name and the telephone number of the caller. A numeral 45 denotes a voice VOX signal detection controller in a facsimile main unit controller necessary to determine whether a voice recording on the road incoming to a phone-answering machine is valid.

A numeral 46 denotes a remote control signal detection controller for detecting a remote control start signal (DTMF) from a telephone line. A numeral 47 denotes an ITU-T30 communications protocol controller for implementing a communications protocol recommended by ITU-T30 to perform facsimile communications. A numeral 48 denotes a CNG signal detection controller for detecting a CNG signal which is contained in facsimile communications phase A and is transmitted from a transmitter. A numeral 49 denotes a CED signal detection controller for detecting a CED signal which is contained in facsimile communications phase A and is transmitted from a receiver. Further, a numeral 50 denotes a phase B-D controller for implementing facsimile communications phases B through D, 51 a facsimile main unit state management section for managing the operating state of the facsimile, 52 a first handset additionally registered for use to the cordless phone controller, and 53 a second handset additionally registered for use, and numerals 54 through 59 third to eighth handsets.

Operation of thus configured related art facsimile equipped with multi-cordless handsets will be described. FIG. 4 is a sequence chart of inter-module communications of a related art facsimile equipped with multi-cordless handsets.

In FIG. 4, when a ringing signal is received from the telephone line (sq21), the line controller 42 of a facsimile main unit controller 39 is activated and the ringing signal is detected by the ringing detection controller 43 of the facsimile main unit controller 39 (sq22). In case it is determined that the ringing signal is present, the bell of the facsimile main body is rung (sq23) and a request is issued to the serial communications controller 41 of the facsimile main unit controller 39 to transmit a ringing request to the cordless phone controller 31 (sq24).

The request is transmitted from the serial communications controller 41 to the serial communications controller 38 of the cordless phone controller 31 (sq25). The serial communications controller 38 reports receipt of a ringing request to the cordless phone state management section 36 (sq26). The cordless phone state management section 36 searches for the idle states of the eight cordless phones 52 through 59 and requests a radio communications controller 37 to transmit a ringing receipt signal to idle (not busy) handsets (sq27). The radio communications controller 37 transmits a ringing receipt signal to the channels of the idle handsets (sq28) As a result, a large delay in ringing start occurs between the ringing of the facsimile main unit and the ringing of the cordless phone in sq28.

In FIG. 4, in case the terminating facsimile starts to be rung, a CNG signal appears on the telephone line. The CNG signal is detected by the CNG signal detection controller 48 (sq31). At the same time the facsimile reception is activated, a request for a facsimile receiving state notice is issued via a facsimile/cordless phone common state management section 41 (sq32) to the serial communications controller 41 (sq33). The serial communications controller 38 of the cordless phone controller receives this request and reports the facsimile state to the cordless phone state management section 36 (sq34).

Further, when an intercom request is made on any of the cordless handsets 52 through 59 during facsimile communications, an intercom request signal is transmitted to the radio communications controller 37 from the cordless phone (sq41). The signal reaches the facsimile main unit controller 39 via the serial communications controller 38 (sq42) to make the intercom request. The request signal is transmitted from the serial communications controller 38 to the serial communications controller 41 (sq43). Receiving this request, the serial communications controller 41 reports receipt of the request to the facsimile/cordless phone common state management section 40 (sq44). In case the system throughput during facsimile communications is exceeded, a busy signal is issued. In case the request is within the system throughput, the serial communications controller 41 issues an answer signal to make a transition to the processing to allow simultaneous operation. That is, an answer signal is transmitted to the serial communications controller 41 (sq46). The cordless handsets 52 through 59 are called (sq49) via the serial communications controller 38 (sq47) and the radio communications controller 37 (sq48).

In this way, according to the related art, simultaneous operation of cordless communications and facsimile communications depends on the load of facsimile communications. In some cases, simultaneous operation with cordless communications is inhibited while facsimile communications are in progress.

The above-mentioned related-art facsimile equipped with handsets includes individual state management systems and circuit controllers in both the facsimile main unit controller and the cordless phone controller. The two controllers are connected via respective serial communications controllers. This complicates software structure and causes a delay in the response time from detection of various signals to state transition. Insufficient throughput of the CPU on the facsimile main unit controller limits the conditions for racing of operations of facsimile function and cordless phone function as well as fails to support recent high-speed communications and performance upgrades of a high-speed printer and a high-speed copier. These problems impair optimization of hardware components and invite manufacturing problems of increased cost from the viewpoint of the number of components.

### SUMMARY OF THE INVENTION

This invention aims at optimizing the system configuration of a telephone controller and a facsimile main unit controller and providing a facsimile which performs efficient state transition and signal processing.

A facsimile according to this invention comprises a facsimile main unit and a plurality of handsets, the facsimile further comprising a telephone controller for controlling communications with the handsets and a facsimile communications controller for controlling facsimile communications, characterized in that the telephone controller comprises a radio communications section for performing radio communications with the handsets, a line controller connected to a telephone line for receiving various signals such as a ringing signal, a speech signal and a facsimile signal as well as controlling the lines, a first management section for controlling voice communications and communications related to the facsimile signal, and a first communications section for performing serial communications of a facsimile signal with the facsimile communications controller, that the facsimile communications controller comprises a second communications section for performing serial communications of a facsimile signal from a first communications section of the telephone controller and a second management section for receiving a facsimile signal from the second communications section and managing the facsimile function, and that the line controller comprises a ringing detection controller and when the ringing detection controller has detected a ringing signal from the telephone line, the first management section instructs the radio communications section to transmit a ringing request signal to the handsets.

### BRIEF DESCRIPTION OF THE DRAWINGS

FIG. 1 is a block diagram of a facsimile according to Embodiment 1 of the invention;

FIG. 2 is a sequence chart of inter-module communications of a facsimile according to Embodiment 1 of the invention;

FIG. 3 is a block diagram of a related art facsimile equipped with multi-cordless handsets; and

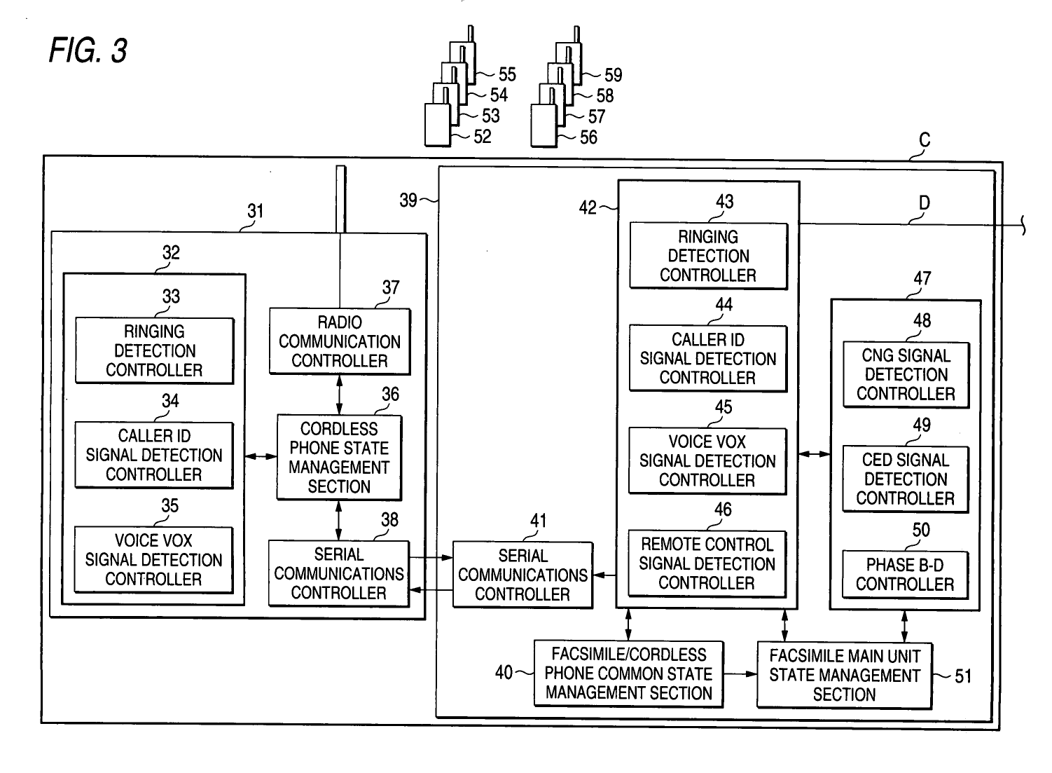

FIG. 4 is a sequence chart of inter-module communications of a related art facsimile equipped with multi-cordless handsets.

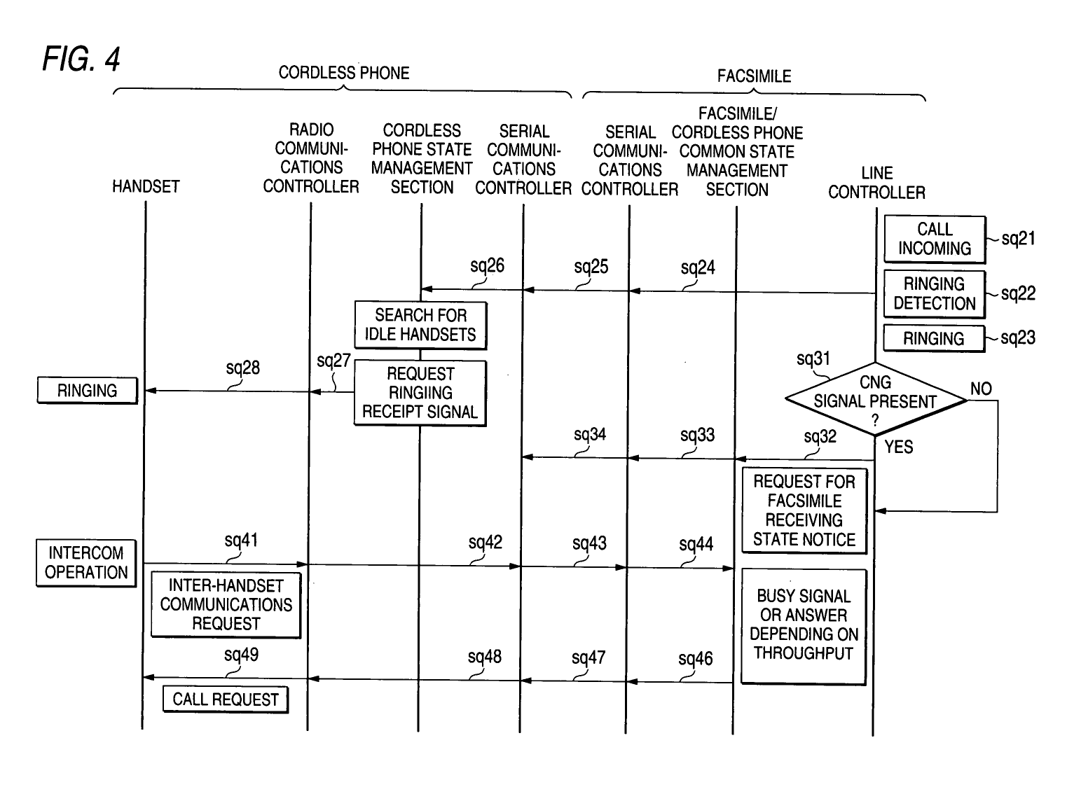

### DESCRIPTION OF THE PREFERRED EMBODIMENTS

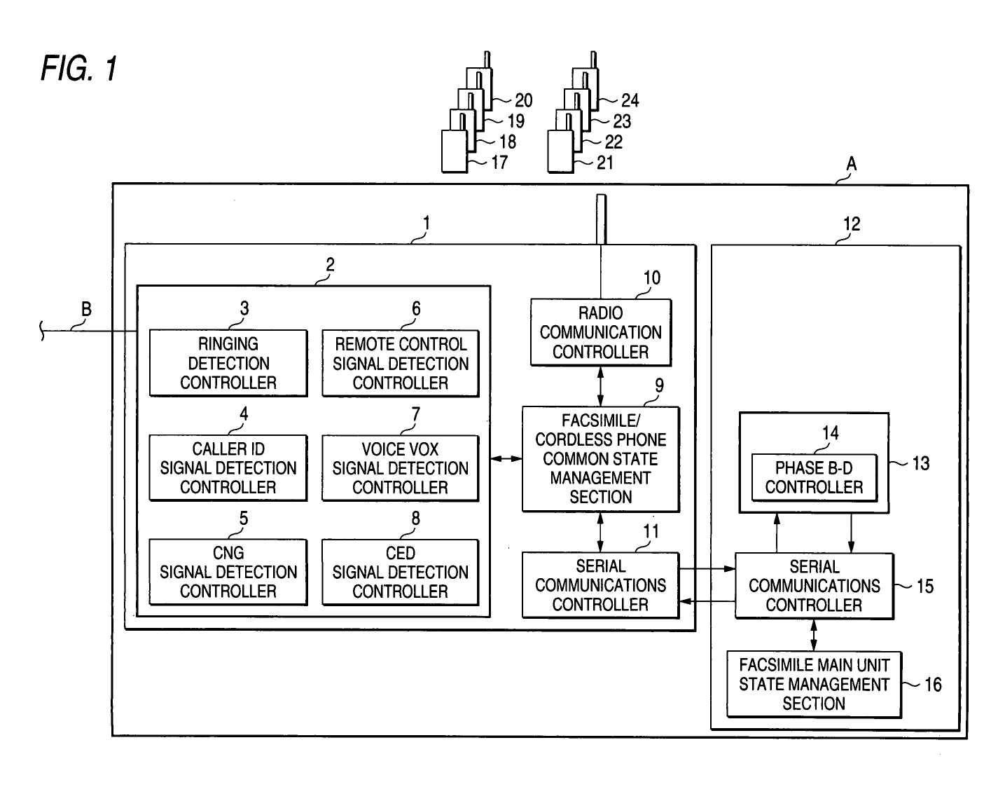

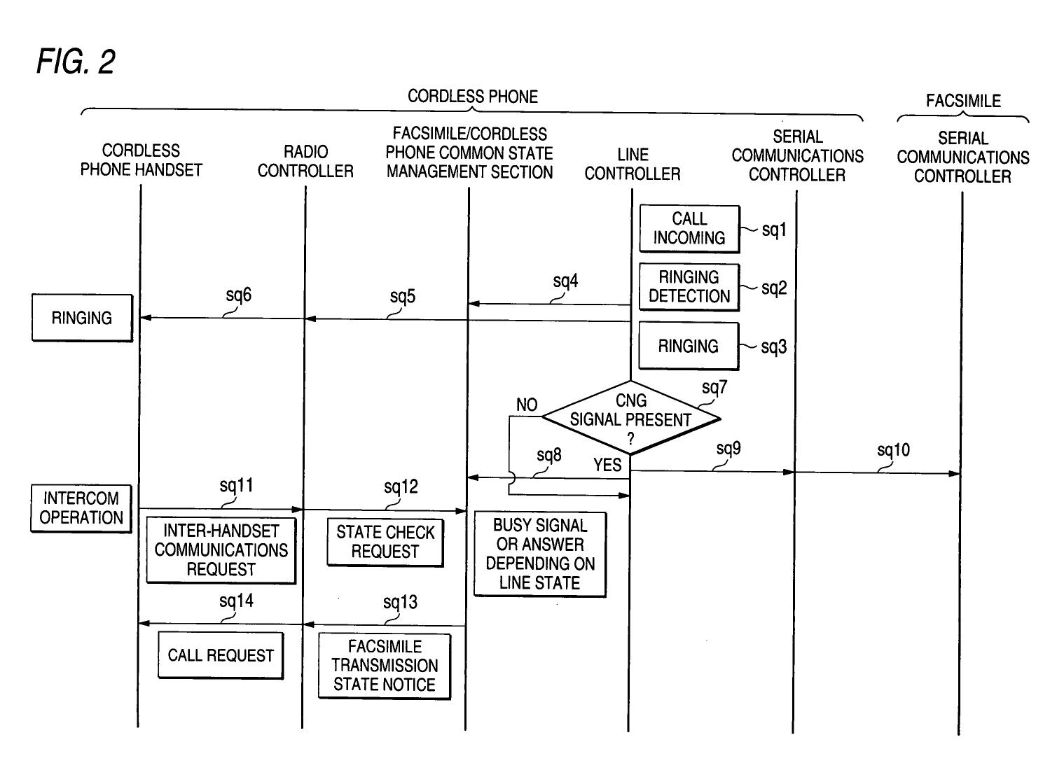

Embodiments of a facsimile according to the invention are described below referring to FIGS. 1 and 2. FIG. 1 is a block diagram of a facsimile equipped with multi-cordless handsets. FIG. 2 is a sequence chart of communications in an embodiment of the facsimile according to the invention.

In FIG. 1, on the cordless phone controller, a numeral 1 denotes a cordless phone controller for controlling eight cordless phones 17 through 24 (mentioned later) added on a facsimile A equipped with multi-cordless handsets. A numeral 2 denotes a line controller for controlling various signals flowing over a telephone line B.

A numeral 3 denotes a ringing detection controller in the line controller for detecting a ringing signal, 4 a caller ID signal detection controller for detecting the name and the telephone number of the caller. A numeral 5 denotes a CNG signal detection controller for detecting a CNG signal (originating tone signal) which is contained in facsimile communications phase A for call setup and is transmitted from a transmitter.

A numeral 6 denotes a remote control signal detection controller for detecting a remote control start signal (DTMF) from a telephone line. A numeral 7 denotes a voice VOX signal detection controller necessary to determine whether a voice recording on the road incoming to a phone-answering machine is valid. A numeral 8 denotes a CED signal detection controller for detecting a CED signal (called station acknowledge signal) which is contained in communications phase A and is transmitted from a receiver in order to implement a facsimile communications protocol recommended by ITU-T30.

A numeral 9 denotes a facsimile/cordless phone common state management section for performing overall management of the states of both a facsimile main unit controller 12 and the cordless phone controller 1 mentioned later. A numeral 10 denotes a radio communications controller for performing communications via a radio signal with the eight cordless phones. A numeral 11 denotes a serial communications controller of a cordless phone controller for performing communications between the CPU in the facsimile main unit controller and the CPU in the cordless phone controller.

Next, the configuration of the facsimile main unit controller is described below. A numeral 12 denotes a facsimile main unit controller for providing functions on the facsimile such as facsimile communications, a copier and a printer of a facsimile equipped with multi-cordless handsets. A numeral 13 denotes an ITU-T30 communications protocol controller for implementing a communications protocol recommended by ITU-T30 to perform facsimile communications. A numeral 14 denotes a phase B-D controller for implementing facsimile communications phases B through D. The communications phase B is a procedure followed after call setup of communications phase A for facsimile communications and before message transmission. The communications phase C is a procedure for actually transmitting a message. The phase D is a procedure to confirm that the message transmission procedure is complete and the phase E a call release procedure.

A numeral 15 denotes a serial communications controller in a facsimile main unit controller for performing communications between the CPU in the facsimile main unit controller and the CPU in the cordless phone controller. A numeral 16 denotes a facsimile main unit state management section for managing the operating state of the facsimile, 17 a first handset additionally registered for use to the cordless phone controller, 18 a second handset additionally registered for use. A numeral 19 denotes a third handset, 20 a fourth handset, 21 a fifth handset, 22 a sixth handset, 23 a seventh handset, and 24 an eighth handset.

Referring to FIG. 2, inter-module communications of a facsimile equipped with multi-cordless handsets are described. In FIG. 2, when a ringing signal is received from the telephone line (sq1), the line controller 2 is activated and the ringing signal is detected by the ringing detection controller 3 (sq2). In case it is determined that the ringing signal is present by the ringing detection controller, the bell ringing is started in real time by controlling a ringing circuit (not shown) in the cordless phone controller 1 (sq3) as well as a state update request is issued to the facsimile/cordless phone common state management section 9 (sq4). A ringing request is transmitted to idle cordless handsets (sq6) among the eight cordless phones 17 through 24 via the radio communications controller 10 (sq5).

As far as this ringing is concerned, unlike the related art system, a state notification is not made on the serial communications via two serial communications controllers. Thus, a delay in the ringing start time does not occur between the facsimile main unit and the cordless phones 17 through 24.

In case the terminating facsimile starts to be rung, a CNG signal appears on the telephone line. The CNG signal is detected by the CNG signal detection controller 5 in the line controller 2 (sq7). A state update request is issued from the line controller 2 to the facsimile/cordless phone common state management section 9 (sq8). A facsimile reception activation request is issued to the facsimile main unit controller 12 via the serial communications controller 11 (sq9) and the serial communications controller 15 (sq10), then facsimile communications start. In this practice, the corresponding flag is set in the facsimile/cordless phone common state management section 9 (not shown).

Further, when an intercom request is made on any of the cordless handsets 17 through 24 during facsimile communications, an inter-handset communications request signal is transmitted to the radio communications controller 10 (sq11). Receiving this request signal, the radio communications controller 10 transmits a command signal for state check request to the facsimile/cordless phone common state management section 9 (sq12). Receiving the command signal, the facsimile/cordless phone common state management section 9 checks the line state, and confirming that a flag to indicate ongoing facsimile communications is set, it transmits a state notice that facsimile transmission is on the way to the radio communications controller 10 without issuing a request to transmit a command to the serial communications controller 11 (sq13). Receiving this notice, the radio communications controller 10 transmits an inter-handset call request signal to a corresponding handset among the cordless phones 17 through 24 (sq14).

This provides an intercom between handsets during facsimile communications without the intervention of the facsimile main unit controller 12.

When a state check request (sq12) is received, in case the called handset is engaged in an outgoing call, the facsimile/cordless phone common state management section 9 issues a talking state notice to the radio controller to notify that the called handset is busy. In case the called handset is not engaged in an outgoing call, the facsimile/cordless phone common state management section 9 issues a call available notice to the radio controller to call the called handset. The cordless phone controller as a standalone unit is in charge of inter-handset communications without generating a state notice (serial communications) in communications with the facsimile main unit controller. This allows inter-handset communications in a short time with smaller volume of processing.

As mentioned above, according to the facsimile equipped with multi-cordless handsets, a delay in the signal processing is eliminated in both the cordless phone controller and the facsimile main unit controller. Cordless handsets can operate simultaneously without limitation during facsimile communications, which has been difficult.

Related art individual state management and line control on both the facsimile main unit controller and the cordless phone controller have been integrated into the cordless phone controller. Control of phase A alone is isolated from the facsimile communications phases and managed by the line controller in a centralized fashion. In implementing inter-module communications system between control modules, the cordless phone controller alone controls inter-handset communications during facsimile communications without generating a state notice (serial communications) to the facsimile main unit controller. This optimizes the system configuration of the cordless phone controller and the facsimile main unit controller, thereby providing efficient state transition and signal processing as well as a system configuration which is low-cost and expandable.

What is claimed is:

1. A facsimile comprising a facsimile main unit and a plurality of handsets, the facsimile further comprising:
a telephone controller, which controls communications with the handsets; and
a facsimile communications controller, which controls facsimile communications,
wherein the telephone controller comprises:
a radio communications section, which performs radio communications with the handsets;
a line controller, which is connected to a telephone line and which receives various signals such as a ringing signal, a speech signal and a facsimile signal and which controls the telephone line;
a first management section, which controls voice communications and communications related to the facsimile signal; and
a first communications section, which performs serial communications of a facsimile signal with the facsimile communications controller;
wherein the facsimile communications controller comprises:
a second communications section, which performs serial communications of a facsimile signal from the first communications section of the telephone controller; and
a second management section, which receives a facsimile signal from the second communications section and manages the facsimile function; and
wherein the line controller comprises a ringing detection controller and when the ringing detection controller has detected a ringing signal from the telephone line, the first management section instructs the radio communications section to transmit a ringing request signal to the handsets.

2. The facsimile according to claim 1, wherein the line controller comprises a CNG signal detector and when the CNG signal detector has detected a CNG signal, the first management section transmits a facsimile receipt request signal to the second management section via the first communications controller and the second communications section of the facsimile communications controller.

3. The facsimile according to claim 1, wherein when the radio communications section has received from the handsets a signal to request communications with other handsets, the first management section instructs the radio communications section to transmit a call request signal to the other handsets.

4. The facsimile according to claim 1, wherein when the radio communications section has received from the handsets a signal to request communications with the other handsets, the first management section detects whether the other handsets are engaged in communications and, in case they are engaged in communications, instructs said radio communications section to transmit a busy signal to the handsets.
